(19) United States
(12) Patent Application Publication
(10) Pub. No.: US 2008/0308957 A1
(43) Pub. Date: Dec. 18, 2008

(54) METHOD AND APPARATUS FOR FORMING A MINIATURE LENS

(76) Inventor: Alan Symmons, Orlando, FL (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/015,964

(22) Filed: Jan. 17, 2008

Related U.S. Application Data
(60) Provisional application No. 60/880,992, filed on Jan. 18, 2007.

(51) Int. Cl. B29D 11/00

(52) U.S. Cl. 264/1.1; 425/236

(57) ABSTRACT

A method and apparatus for precisely manufacturing a miniature lens for use in a digital camera for a cell phone, for example. The lens is manufactured using an optic pin that creates an optical surface of the lens and a mechanical alignment portion of the outer diameter of the lens in a single step. For example, the optic pin may be created in a single diamond-turning process.

### RELATED APPLICATIONS

This application claims priority to U.S. provisional patent application No. 60/880,992, filed Jan. 18, 2007, and entitled “METHOD AND APPARATUS FOR FORMING A MINIATURE LENS,” which is hereby incorporated herein by reference in its entirety.

### FIELD OF THE INVENTION

The method and apparatus disclosed herein relate generally to manufacturing lenses and more specifically to precisely forming a miniature lens for use, for example, in digital cameras.

### BACKGROUND OF THE INVENTION

In the area of digital cameras such as for use in cell phones, the size and quality of devices are largely dictated by the lens assemblies used therein. The lens assemblies typically utilize more than one lens in combination to form an image on a detector array. Relative alignment of the lenses and optical surfaces affects the quality and resolution of the image projected on the detector array. Such alignment of the lenses in a lens assembly includes the alignment between the outer diameter (OD) of a lens with respect to the front and rear optical surfaces of the lens, the alignment between the front and rear optical surfaces of a lens, and the alignment between lenses in the lens assembly.

In recent times consumer devices have been shrinking in size while maintaining or improving quality in comparison to larger predecessors. As digital cameras, particularly the lens assemblies, become smaller, manufacturing tolerances become more stringent. For example, some lenses currently used in miniaturized cameras require that the optical axes for the front and rear optical surfaces of a lens align within 10 microns. This tolerance is projected to decrease to less than 5 microns. Element-to-element alignment constraints are also below 5 microns. What is needed are methods of manufacturing lenses with increased precision.

### SUMMARY OF CERTAIN EMBODIMENTS

A wide variety of embodiments of the invention are disclosed herein. Certain of these embodiments enable the manufacture of miniature lenses with increasing precision in order to preserve the resolution of images produced by smaller cameras and lens assemblies.

One embodiment of the invention comprises a method for manufacturing a lens for use in a miniature camera assembly wherein the lens is shaped to mount the lens with improved tolerance. The method comprises providing first and second receivers that respectively house first and second optic pins. Each of the optic pins haves distal ends respectively contoured to form first and second optical surfaces of the lens. The method further comprises disposing the first optic pin and receiver with respect to the second optic pin and receiver to form a cavity. A lens is formed by flowing material into the cavity. The lens has first and second optical surfaces respectively formed by the optic pins. The lens also has a first outer diameter across a first direction and a second outer diameter across a second direction. The first outer diameter is larger than the second outer diameter. The first outer diameter only is for mounting of the lens. The method additionally includes removing the lens from the first and second receivers, after the plastic material has hardened. The first optical surface is formed by the first optic pin and the second optical surface, and the first outer diameter is formed by the second optic pin thereby reducing error in alignment of the second optical surface with the first outer diameter.

Another embodiment of the invention comprises a method for manufacturing a lens having first and second optical surfaces for use in a miniature camera assembly. The method comprises providing a first optic pin having a shape conforming to the first optical surface and providing a second optic pin having a shape conforming to the second optical surface and a locating flange for the lens. The method further comprises juxtaposing the first and second optic pins in a receiver to form a cavity and flowing plastic material into the cavity to form said lens and the first and second optical surface. The locating flange is formed substantially only by the second optic pin and substantially independent of the receiver.

Another embodiment of the invention comprises a method for manufacturing a lens for use in a miniature camera assembly. The lens is shaped to mount the lens with improved tolerance. The method comprises providing first and second receivers respectively housing first and second pins, each of the pins and the receivers having distal ends. The method further comprises disposing the distal end of the first pin and receiver with respect to the second pin and receiver to form a cavity. A lens is formed from material in the cavity. The lens has first and second optical surfaces and a flange thereabout. The lens has a first outer diameter across a first direction and a second outer diameter across a second direction that is orthogonal to the first direction. The first outer diameter is larger than the second outer diameter. The first outer diameter is for mounting of said lens. The lens is removed. The second optical surface and the first outer diameter are formed by the second pin thereby reducing error in alignment of the second optical surface with the first outer diameter.

Another embodiment of the invention comprises a method for manufacturing a lens. The method comprises disposing a first member with respect to a second member to form a cavity therebetween, the second member including a monolithic contoured surface, and forming a lens from material in the cavity. The lens has first and second optical surfaces and a mounting flange disposed about at least a portion of the first and second optical surfaces. The mounting flange has an outer diameter. The method further comprise removing the lens. The second optical surface and the outer diameter of the mounting flange are formed by the monolithic contoured surface thereby reducing error in alignment of the second optical surface with the outer diameter.

Another embodiment of the invention comprises an optic pin for manufacturing a miniature plastic lens. The optic pin comprises a body, an optical forming surface on a distal end of the body, and a mounting flange forming surface on the distal end of the body. The optical forming surface and mounting flange forming surface comprise a monolithic contoured surface.

For purposes of this summary, certain aspects, advantages, and novel features of the invention are described herein. It is to be understood that not necessarily all such advantages may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

### BRIEF DESCRIPTION OF THE DRAWINGS

FIG. 1A illustrates a side-view of one embodiment of an A-side optic pin.

FIG. 1B illustrates a cross-sectional view through the line 1B-1B of the A-side optic pin illustrated in FIG. 1A.

FIG. 1C illustrates a magnified view of the cross-sectional view illustrated in FIG. 1B.

FIG. 2A illustrates a side-view of one embodiment of a B-side optic pin.

FIG. 2B illustrates a cross-sectional view through line 2B-2B of the B-side optic pin illustrated in FIG. 2A.

FIG. 2C illustrates a magnified view of the cross-sectional view of the B-side optic pin illustrated in FIG. 2B.

FIG. 3 illustrates a flow chart of one embodiment of a method for creating an optic pin.

FIG. 4A illustrates a side view of one embodiment of a B-side receiver.

FIG. 4B illustrates a top view of the B-side receiver illustrated in FIG. 4A showing a gate for introducing flowable material.

FIG. 4C illustrates a cross-sectional view through the line 4C-4C of the B-side receiver illustrated in FIG. 4A.

FIG. 4D illustrates a magnified view of the cross-sectional view of the B-side receiver illustrated in FIG. 4C.

FIG. 5A illustrates a perspective view of one embodiment of a B-side optic pin partially inserted into a B-side receiver.

FIG. 5B illustrates a magnified view of the distal end of the B-side optic pin illustrated in FIG. 5A.

FIG. 6A illustrates a first cross-sectional view of one embodiment of an A-side and B-side mold assembly.

FIG. 6B illustrates a magnified view of the first cross-sectional view of the A-side and B-side mold assembly illustrated in FIG. 6A.

FIG. 6C illustrates a second cross-sectional view of the A-side and B-side mold assembly illustrated in FIG. 6A.

FIG. 6D illustrates a magnified view of the second cross-sectional view of the A-side and B-side mold assembly illustrated in FIG. 6C.

FIG. 7A illustrates a front view of one embodiment of a miniature lens.

FIG. 7B illustrates a rear view of the miniature lens illustrated in FIG. 7 A.

FIG. 7C illustrates a side view of the miniature lens illustrated in FIG. 7A.

FIG. 7D illustrates a cross-sectional view through line 7D-7D of the miniature lens illustrated in FIG. 7C.

FIG. 7E illustrates a front perspective view of the miniature lens illustrated in FIG. 7A.

FIG. 7F illustrates a rear perspective view of the miniature lens illustrated in FIG. 7A.

FIG. 8 illustrates a flowchart of one embodiment of a method for manufacturing a miniature lens.

FIG. 9A illustrates a front perspective view of one embodiment of a lens assembly housing.

FIG. 9B illustrates a rear perspective view of the lens assembly housing illustrated in FIG. 9A.

FIG. 10 illustrates a cross-sectional view of the lens assembly of FIGS. 9A and 9B.

FIG. 11A illustrates a side view of one embodiment of an ideal lens.

FIG. 11B illustrates a side view of one embodiment of a 3-lens lens assembly comprised of lenses similar to the lens illustrated in FIG. 11A.

FIG. 12A illustrates a side view of one embodiment of a lens having alignment error between first and second optical axes; between the first optical axis and a mechanical axis; and between the second optical axis and the mechanical axis.

FIG. 12B illustrates a side view of one embodiment of a 3-lens lens assembly comprised of lenses similar to the lens illustrated in FIG. 12A.

FIG. 13A illustrates a side view of one embodiment of a lens having only error between a first optical axis and a mechanical axis.

FIG. 13B illustrates a side view of one embodiment of a 3-lens lens assembly comprised of lenses similar to the lens illustrated in FIG. 13A.

### DETAILED DESCRIPTION OF CERTAIN EMBODIMENTS

Systems and methods which represent one embodiment of an example application of the invention will now be described with reference to the drawings. The drawings in the associated descriptions are provided to illustrate embodiments of the invention and not to limit the scope of the invention. Throughout the drawings, reference numbers may be re-used to indicate correspondence between referenced elements. Variations to the systems, methods, and processes which represent other embodiments will also be described, though it should be understood that still additional embodiments will be apparent to those of skill in the art based upon this disclosure.

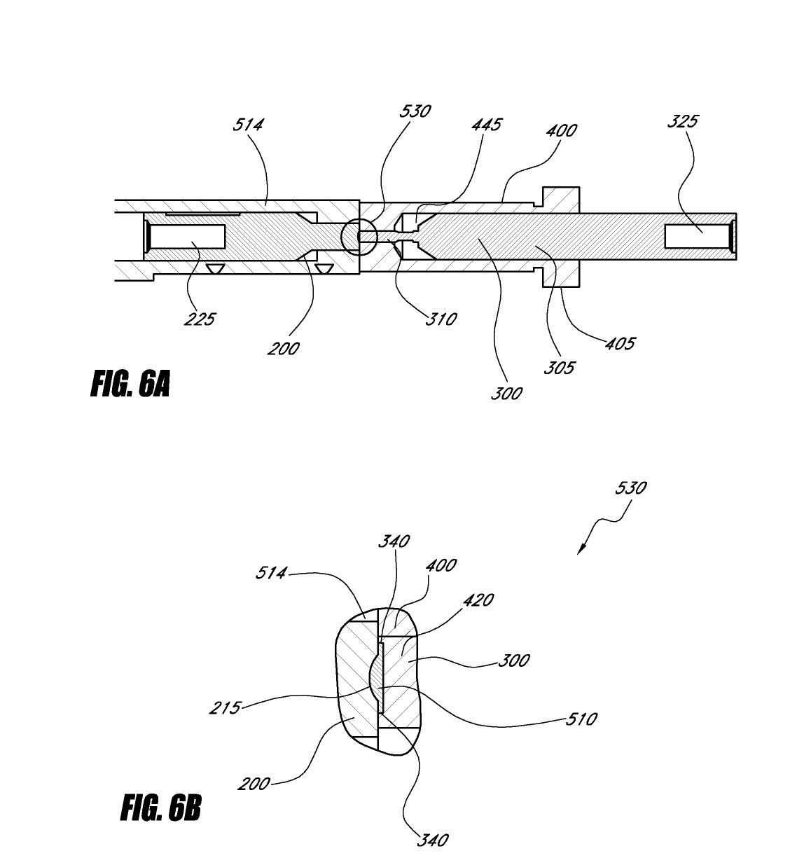

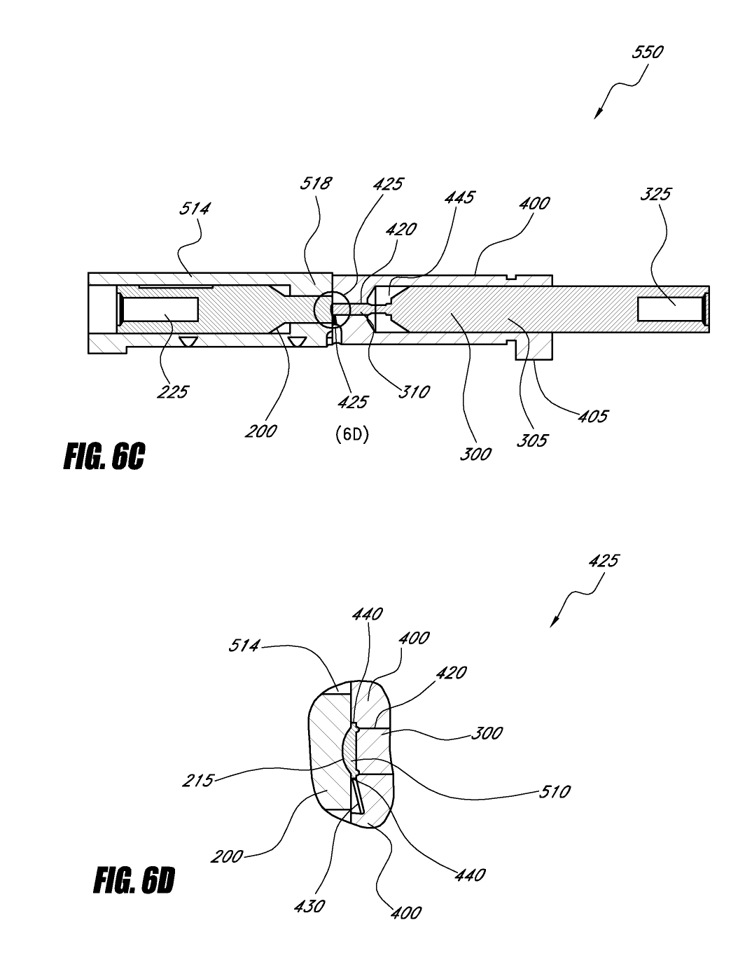

Various embodiments described herein include optic pins and receivers which are described in more detail below. In some embodiments, the optic pins and receivers may be defined as an A-side or B-side optic pin. For ease of reference only, the optic pins and receivers depicted on the left side of the “A-side and B-side mold assembly” (one embodiment of which is illustrated in FIGS. 6A-6D) will be referred to herein as “A-side” optic pins and receivers. Additionally, the optic pins and/or receivers depicted on the right side of the “A-side and B-side mold assembly” (one embodiment of which is illustrated in FIGS. 6A-6D) will be referred to herein as “B-side” optic pins and receivers. Accordingly, an A-side of a lens, as used herein, refers to the side of the lens formed by the A-side optic pin and/or receiver; and the B-side of a lens, as used herein, refers to the side of the lens formed by the B-side optic pin and/or receiver. Alternatively, optic pins and receivers may be referred to as, for example, a “first” optic pin and receiver or a “second” optic pin and receiver and may or may not correspond to the respective A-side and B-side. The naming conventions used herein are intended only for ease of reference. They are in no way intended to limit the appended claims. Accordingly, statements made about the “A-side” of a lens can apply to the “front or rear” side of a lens. Similarly statements made about the “B-side” of one lens can apply to the “front or rear” side of a lens.

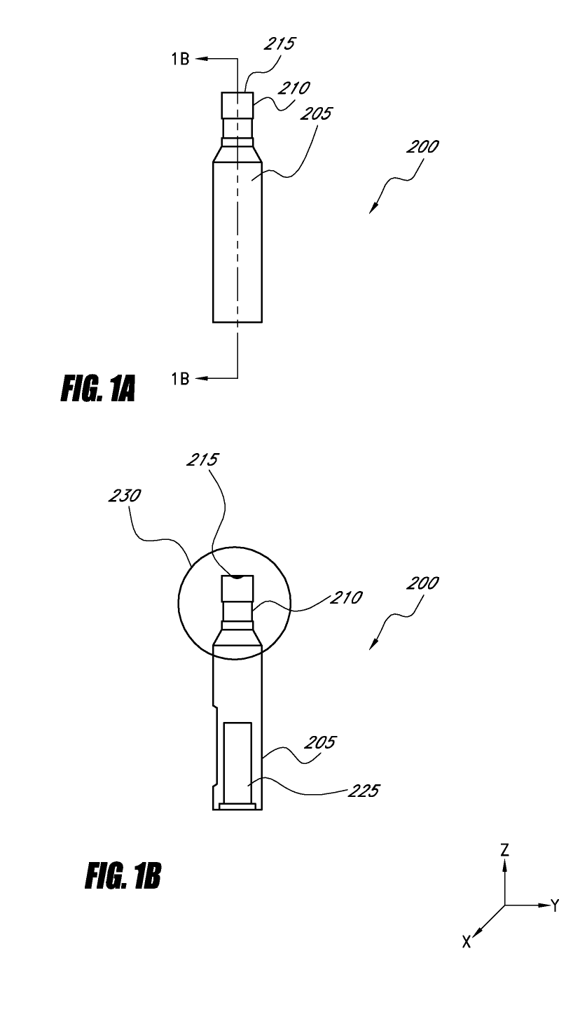

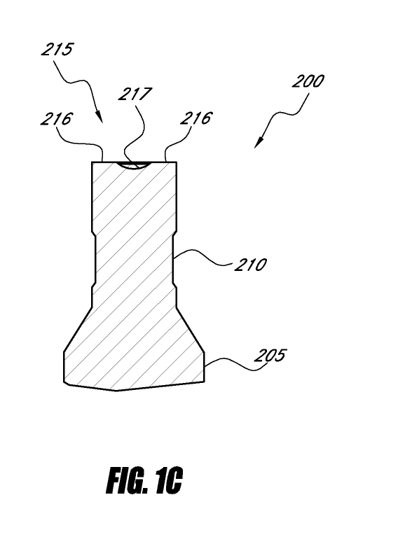

FIG. 1A illustrates a side-view of one embodiment of an A-side optic pin 200. The exterior of the A-side optic pin 200 includes a barrel 205, a neck 210 and a lens forming surface 215. As discussed below, the contours of the barrel 205 and neck 210 may provide a fit for the optic pin 200 when it is placed into the A-side receiver. FIG. 1B illustrates a cross-sectional view of one embodiment of the A-side optic pin 200 illustrated in FIG. 1A along line 1B-1B. The core of the barrel 205 contains a cavity 225. As discussed below, the cavity 225 may be used to position the A-side optic-pin 200 when it is placed inside the A-side receiver.

FIG. 1C illustrates a magnified view of the cross-sectional view illustrated in FIG. 1B at the position indicated by circle 230. The distal end of the optic pin 200 includes the lens forming surface 215. In one embodiment, the lens forming surface 215 includes two regions: a mechanical mount forming region 216 and an optical surface forming region 217. The mechanical mount forming region 216 forms the periphery of the lens on the A-side, providing a shape to the periphery that is compatible with adjacent lenses in a lens assembly, a lens housing in which the lens is placed, or another element in the lens assembly. Accordingly, in some embodiments, the contours of the mechanical mount forming region 216 may influence the positioning of the lens within a lens assembly. In some embodiments, the optical properties of the periphery of the lens do not affect the optical performance of the lens. The optical surface forming region 217 forms the A-side optical surface of the lens. Accordingly, the contour of the optical surface forming region 217 shapes the contour of the lens, thereby influencing the lens's optical characteristics.

It is recognized that the distal end 215 of the A-side optic pin 200 can have alternate configurations. For example, the mechanical mounting region 216 can have a plurality of heights so as to form a stepped geometry along the periphery of the lens, or it can have a curved surface. Additionally, the optical surface forming region 217 can have a wide range of curvatures (including aspheric curvatures) and may be concave, convex or planar. In some embodiments, the lens forming surface 215 of the A-side optic pin is exclusively comprised of an optical forming region 217, while mechanical mounting features of the lens may be formed by the A-side receiver. A variety of geometries are possible for both the mechanical mount forming region 216 and the optical surface forming region 217.

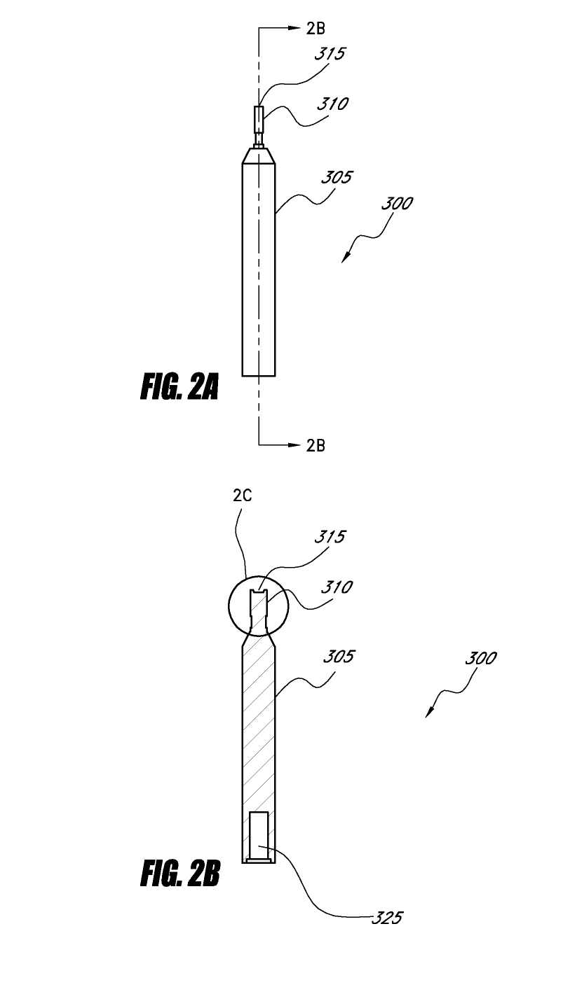

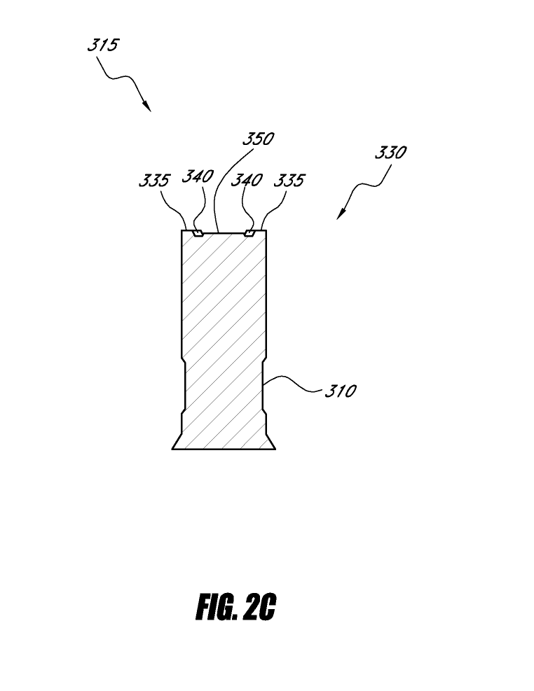

FIG. 2A illustrates a side-view of one embodiment of a B-side optic pin 300. Like its counterpart, the B-side optic pin includes a barrel 305, a neck 310 and a lens forming surface 315. FIG. 2B illustrates a cross-sectional view of one embodiment of the B-side optic pin 300 illustrated in FIG. 2A along line 213-213. The cross-section reveals that the core of the barrel 305 contains a cavity 325. As discussed in more detail below, the cavity 325 can be used to position the B-side optic pin 300 when it is placed in the B-side receiver 400.

FIG. 2C illustrates a magnified view of the cross-sectional view of the B-side optic pin illustrated in FIG. 2B. The lens forming surface 315 of the B-side optic pin 300 comprises an optical surface forming region 350 and a mechanical mount forming region 335. The mechanical mount forming region 335 may be used to shape the periphery of the B-side of the lens. The contour formed on the periphery of the lens influences the positioning with respect to one or more other lenses in the lens assembly.

As shown, in some embodiments, the mechanical mount forming region 335 comprises a tapered surface 340. The tapered surface 340 may be used to accurately and precisely align the lens to an adjacent lens or other component within a lens assembly. For example, the tapered surface 340 of a first lens may contact a complementary tapered surface of an adjacent lens in a lens assembly, thus aligning the two lenses longitudinally along their optical axes and/or laterally with respect to one another. The interlocking tapered surfaces (e.g., 340) of two lenses may also determine the amount of tilt, if any, between the lenses. In some embodiments, the tapered surface 340 additionally facilitates ejection of a lens after it has been formed by the B-side optic pin 300. Ejection from the B-side optic pin 300 may be easier when a tapered surface 340 is present rather than another geometry because the lens may not adhere to the pin 300 as strongly. In some cases, the ease of ejection can be explained by the fact that the tapered surface 340 creates less friction between the lens and the optic pin 300.

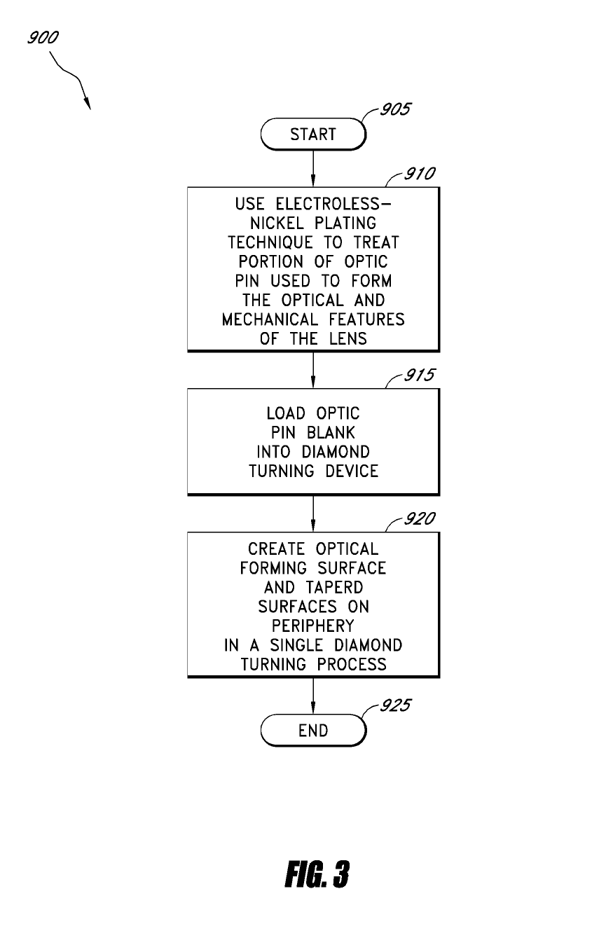

FIG. 3 illustrates a flow chart of one embodiment of a method for creating an optic pin. The process 900 starts 905 using an electroless-nickel plating technique 910 to treat a distal end of, for example, a stainless steel optic pin. The electroless-nickel plating provides a softer surface compared with stainless steel and therefore can be more easily machined, yet the plating is hard enough to withstand the temperatures and pressures of an injection molding process. Other coating or plating techniques, or none at all, may also be used depending on the machining capabilities of the device used to machine the optic pin. Next, the stainless steel optic pin plank is loaded into a diamond turning device 915. Diamond turning devices are well known to those skilled in the mechanical arts and are commonly used to shape steel surfaces.

In various embodiments, surfaces for forming both an optical surface and a mechanical mounting surface (for example, a tapered surface) are formed in a single optic pin and during a single diamond turning process 920. This is in contrast to conventional techniques for forming optic pins used in the manufacture of lenses. For example, in conventional techniques, the optic pin may be designed to form only the optical surface of the lens, while a mechanical mounting surface of the lens may be formed by a receiver. The formation of these surfaces by separate components, rather than, for example, a single monolithic optic pin can lead to alignment errors between the optical and mechanical axes of the lens, as described herein. These alignment errors may result from tolerances between conventional optic pins and receivers. In addition, in some embodiments, the formation of both optical and mechanical mounting surfaces in the optic pin using a single machining process improves the alignment of the optical and mechanical axes of lenses manufactured using the optic pin as compared, for example, to an optic pin with optical and mechanical mount forming surfaces that were machined using separate machining processes.

Forming both the optical forming surface and the mechanical mount forming surface in a single diamond turning process reduces irregularities in the lens forming surface. Errors may be introduced if the optic pin is removed from the diamond turning device between the creation of the optical forming surface and the mechanical mounting surface. Even though such errors may be microscopic, they can substantially alter the performance characteristics of the lenses and lens assemblies disclosed herein. While, FIG. 3 illustrates one example of a method for fabricating an optics pin, other methods may also be used.

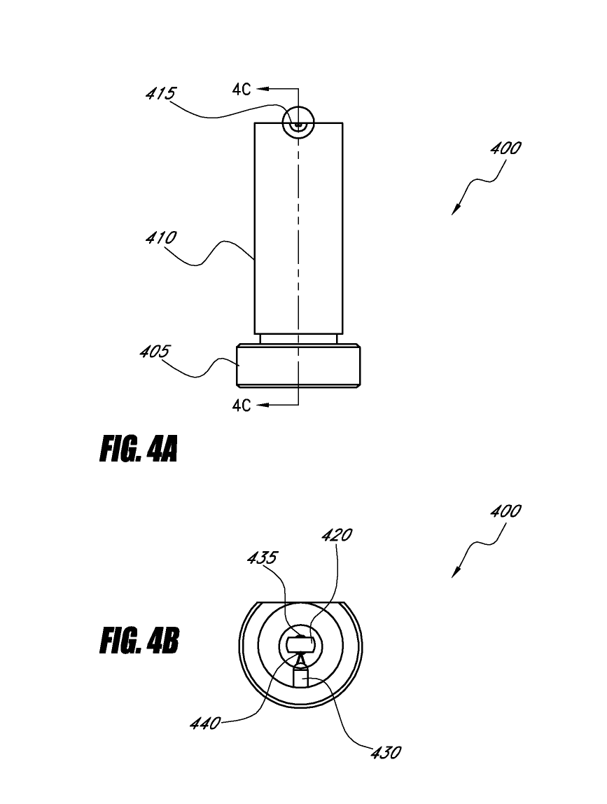

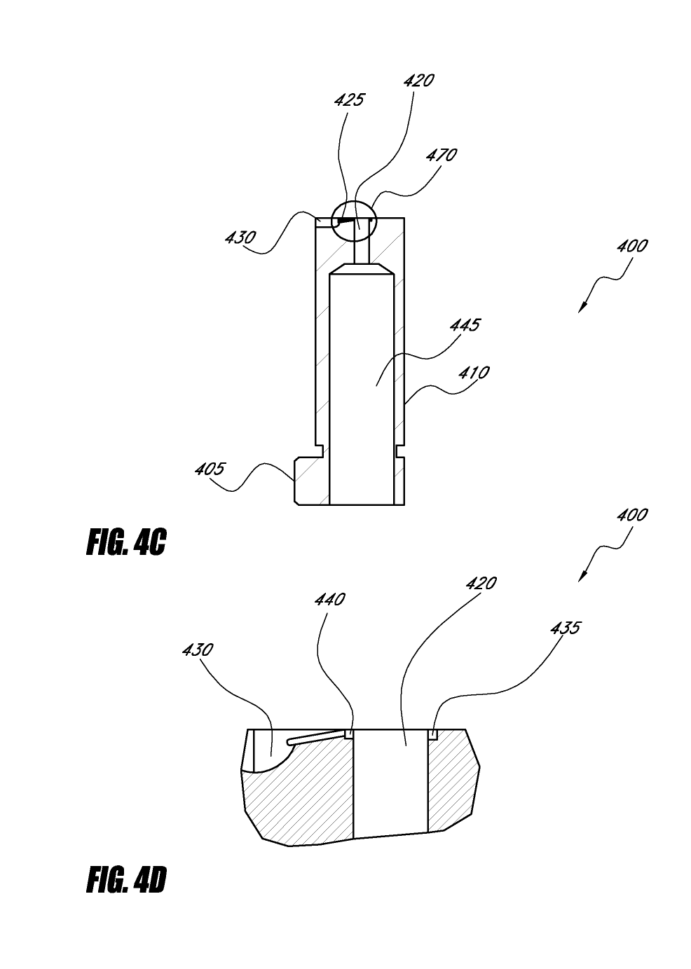

FIG. 4A illustrates a side view of one embodiment of a B-side receiver 400. The B-side receiver 400 includes a base 405, a barrel 410, and a mating interface 415. The geometry of the base 405 and the barrel 410 may be designed to fit the receiver into a mold assembly that may house one or more A-side and B-side receiver pairs. The mating interface 415 contacts the A-side receiver when the lens is formed. FIG. 4B illustrates a top view of one embodiment of the B-side receiver 400 illustrated in FIG. 4A. The top view shows the mating interface 415. The mating interface 415 is comprised of an optic pin insertion cavity 420, a gate 430, and lens forming surfaces 435, 440. The optic pin insertion cavity 420 permits the lens forming surface 315 of the B-side optic pin 300 to protrude beyond the mating interface 415 of the B-side receiver 400. The gate 430 is a contoured feature in the mating interface that permits the plastic material used for the lens to be injected or otherwise inserted into the mold cavity. In one embodiment, the plastic material used for the lens comprises acrylic, polycarbonate, or polyolefins. One example of polymer material that may be used comprises Zeone®, available from Zeon Chemicals. Other plastics or polymeric material may also be used. In addition, still other materials may be used as well.

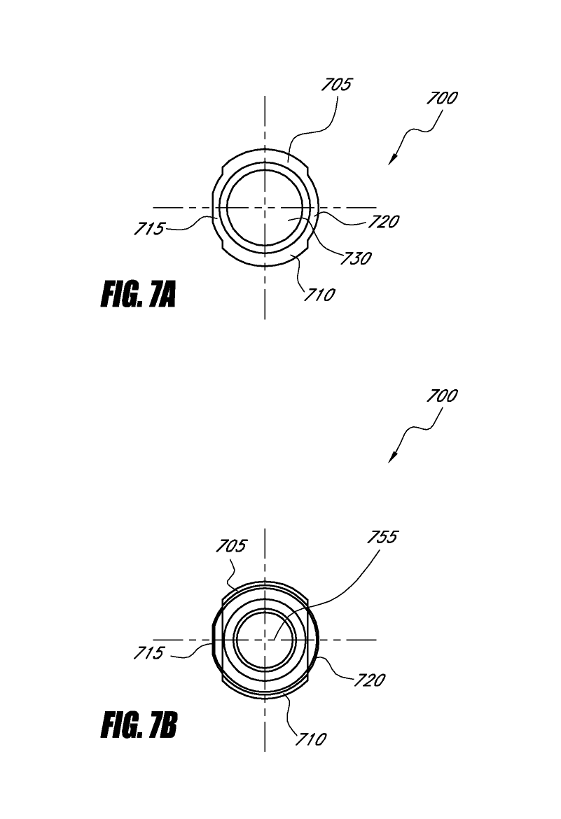

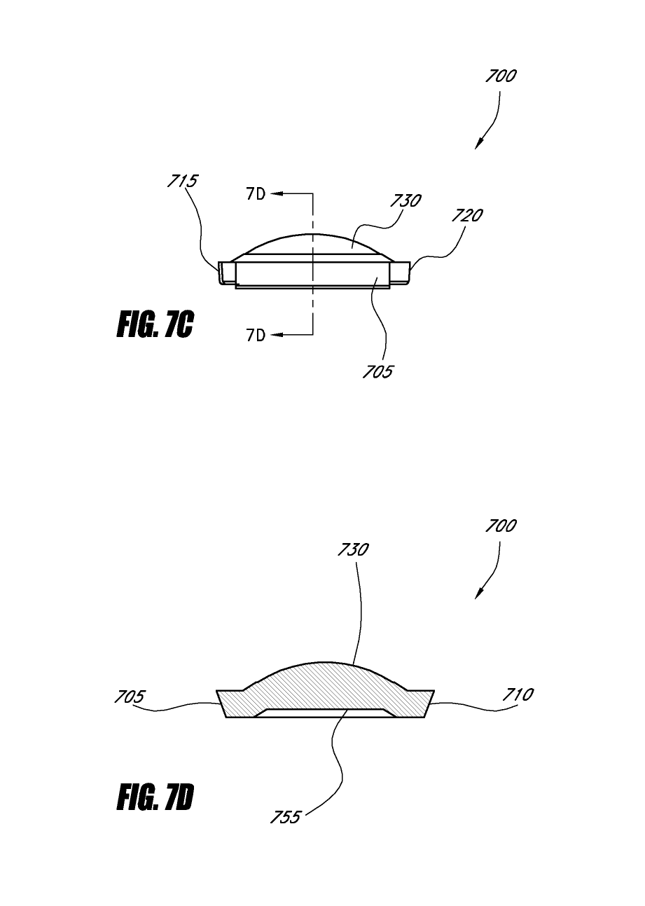

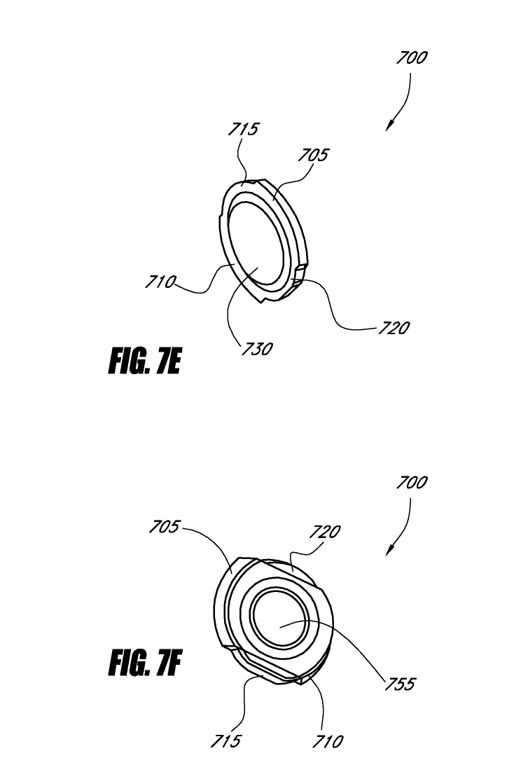

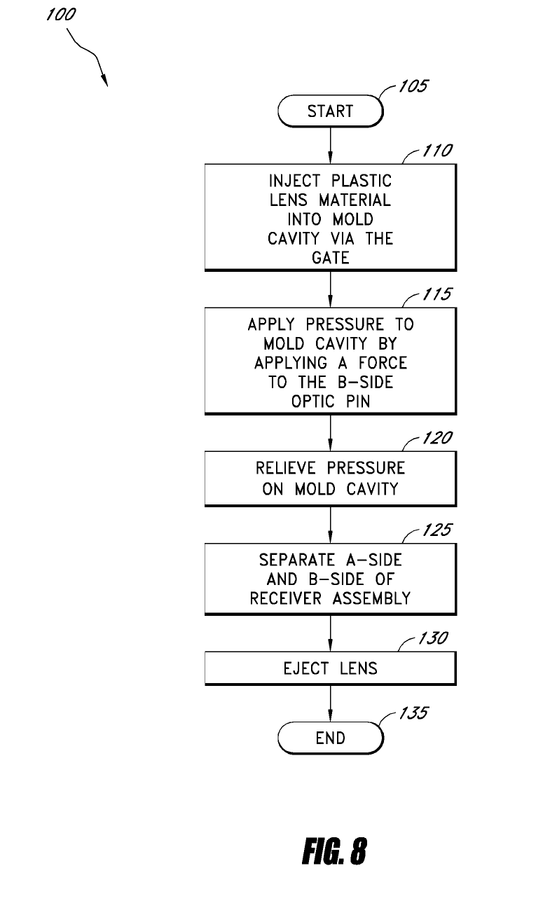

The lens forming surfaces 435, 440 are contoured portions of the mating interface 415 of the receiver that may be used to shape a portion of the periphery of the lens. For example, the lens forming surfaces 435, 440 of the B-side receiver 400 are used in some embodiments to form non-optical surfaces in regions around the periphery of the lens where mechanical mounting surfaces are not formed by the B-side optic pin 300, as described later in more detail with reference to FIGS. 6 and 7. As shown in the illustrated embodiment of FIG. 4B, the lens forming surfaces 435 and 440 form two of the four “sides” of the outer diameter of the lens and the optic pin forms the other two “sides” of the outer diameter. This is explained in greater detail with respect to FIGS. 6 and 7. In a some embodiments, the portions of the outer diameter of the lens that are formed by the B-side receiver 400, unlike those formed by the B-side optic pin 300, are not used for positioning the lens with respect to other lenses in a lens assembly. In some embodiments, the portions of the outer diameter formed by the B-side receiver 400 do not contact any other lens in the lens assembly. In yet other embodiments, the mating interface 415 of the B-side receiver 400 does not form any part of the lens's outer diameter. Rather, the lens forming surface of the B-side optic pin forms the entire outer diameter of the lens.

FIG. 4C illustrates a cross-sectional view of one embodiment of the B-side receiver 400 illustrated in FIG. 4A; and FIG. 4D illustrates a magnified view of one embodiment of the cross-sectional view of the B-side receiver illustrated in FIG. 4C at the position indicated by circle 470. The cross-section shows cavity 445 in which the B-side optic pin 300 is placed. Also, the cross-section more clearly illustrates the geometry of the gate 430 which comprises a channel or pathway in the receiver that permits the lens material to be inserted or flowed into the cavity.

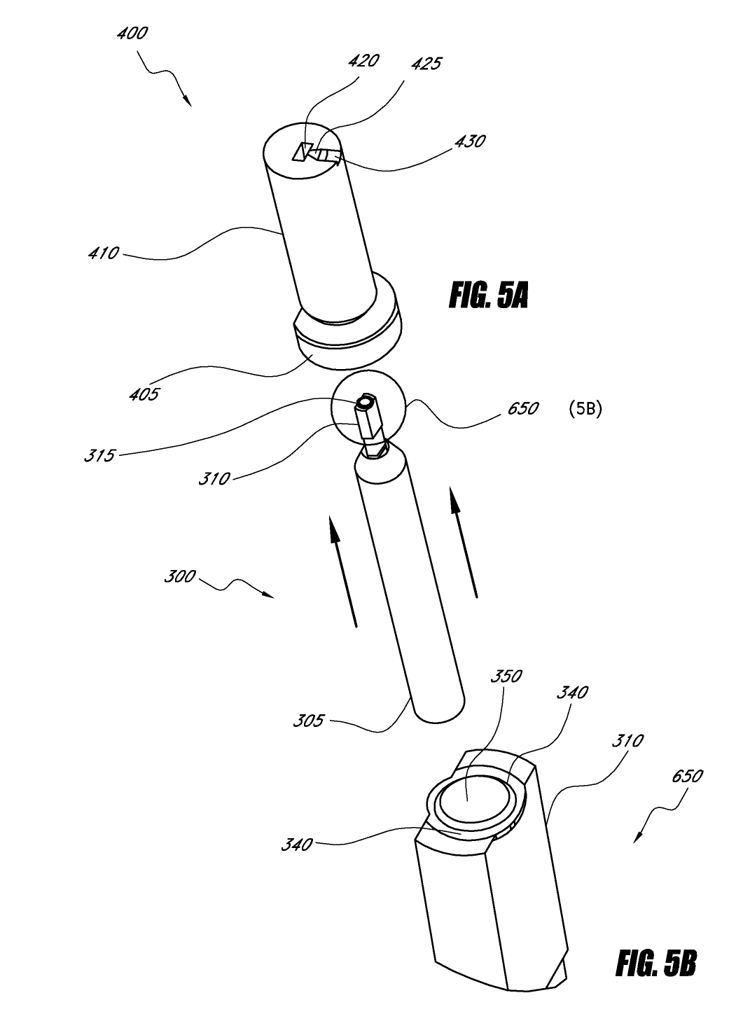

FIG. 5A illustrates an exploded perspective view of one embodiment of a B-side optic pin 300 partially inserted into a B-side receiver 400; and FIG. 5B illustrates a magnified view of one embodiment of the B-side optic pin 300 illustrated in FIG. 5A at the position indicated by circle 650. The B-side optic pin 300 is inserted in cavity 445, and the neck 310 of the optic pin 300 fits into the optic pin insertion cavity 420. At some positions within the cavity 445, the lens forming portion of the B-side optic pin 300 extends beyond the mating interface 415 of the B-side receiver 400 when the optic pin is placed in the optic pin insertion cavity 420.

FIG. 6A illustrates a first cross-sectional view of one embodiment of an A-side and B-side mold assembly. To form the mold assembly, the A-side receiver 514 and the B-side receiver 400 are mated together such that the distal end of the A-side receiver 514 is in contact with the distal end of the B-side receiver 400. The A-side optic pin 200 is located inside the A-side receiver 514. The positioning pin 225 in the A-side receiver determines the position of the A-side optic pin 200 within the A-side receiver 514. In the illustrated embodiment, the position of the A-side optic pin 200 is fixed. The B-side optic pin 300 is located inside the B-side receiver 400. The position of the B-side optic pin 300 within the B-side receiver 400 is determined by the B-side positioning pin 325. In the illustrated embodiment, the B-side optic pin 300 is movable with respect to the B-side receiver 400. The extent to which the B-side optic pin 300 can move within the B-side receiver 400 can be limited by the geometry of the cavity 445 inside the B-side receiver 400.

In another embodiment, the A-side optic pin 200 is movable with respect to the A-side receiver 514, and the B-side optic pin 300 is fixed with respect to the B-side receiver 400. In yet another embodiment, the A-side optic pin 200 is movable with respect to the A-side receiver 514 and the B-side optic pin 300 is movable with respect to the B-side receiver 400. In further embodiments, the A-side optic pin 200 is fixed with respect to the A-side receiver 514, and the B-side optic pin 300 is fixed with respect to the B-side receiver 400.

FIG. 6B illustrates a magnified view of one embodiment of the first cross-sectional view of the A-side and B-side mold assembly illustrated in FIG. 6A at the position indicated by circle 530. In this cross-sectional view, the entire A-side of the lens 510 is formed by the A-side optic pin 200. The distal end 210 of the A-side optic pin 200 is contoured to form the optical surface of the lens 510 via the optical forming surface 215, as well as the flat front surfaces of the mechanical locating, or mounting, flanges of the lens 510. In the illustrated embodiment, the A-side receiver 514 does not form any portion of the A-side of the lens 510. In other embodiments, the A-side optic pin forms a portion of the A-side of the lens, and the A-side receiver forms the remaining portion of the A-side of the lens. In yet other embodiments, the A-side optical surface of the lens could be formed entirely by the A-side receiver.

The B-side of the lens 510 is formed by the B-side optic pin 300. In the illustrated embodiment, the B-side optic pin 300 forms the B-side optical surface of the lens 510 and the depicted portion of the outer diameter of the lens via tapered surfaces 340 on the B-side optic pin 300. In the illustrated cross section, neither the A-side receiver 514 nor the B-side receiver 400 forms any portion of the outer diameter of the lens 510 that affects the mounting of the lens. Instead, the portion of the outer diameter formed by the B-side optic pin 300 via the tapered surfaces 340 is used to mount the lens 510 with respect to other lenses or elements in a lens assembly.

FIG. 6C illustrates a second cross-sectional view of the embodiment of the A-side and B-side mold assembly illustrated in FIG. 6A. The cross-section depicted in FIG. 6C is orthogonal to the cross-section depicted in FIG. 6A. Similar to the cross-section of FIG. 6A, the A-side optic pin 200 fits into the A-side receiver 514 and the B-side optic pin 300 fits into the B-side receiver 400. FIG. 6D illustrates a magnified view of the embodiment of the second cross-sectional view of the A-side and B-side mold assembly illustrated in FIG. 6C at the position indicated by circle 425. The illustrated cross-section shows the gate 430. The gate 430 is the location at which the plastic material used for the lens 510 is injected into the mold cavity. The gate 430 may comprise a channel or pathway fanned between the optic pins 200,300 and the receivers 400, 514. After lens material is flowed into the mold via the gate 430, it ultimately hardens, both within the mold and within the gate. The hardened lens material within the gate protrudes from the molded lens 510 and must be removed.

The A-side of the lens 510 is formed entirely by the A-side optic pin 200. As with the other cross-section, the A-side optic pin 200 forms the optical surface of the lens 510 and the flat front surfaces of the outer portions of the lens depicted in this cross-section. The A-side receiver 514 does not form any portion of the lens 510 in this dimension. On the B-side of the lens 510, the B-side optic pin 300 forms the optical surface of the lens 510. The B-side receiver 400 forms the portion of the outer diameter 440 depicted in this cross-section. In contrast to the cross-section illustrated in FIG. 6B, in the illustrated embodiment, the portion of the lens with an outer diameter determined by the B-side receiver is not used for mounting the lens 510 with respect to other lenses or elements in a lens assembly. Thus, imperfections in the portions of the periphery of the lens formed by the B-side receiver 400 rather than the B-side optic pin 300 do not detrimentally affect alignment tolerances of the lens 510. In addition, since the gate 430 couples to the lens 510 at the portion of the outer diameter that is formed by the B-side receiver 400 and which is not used for mechanical alignment of the lens 510, the hardened lens material in the gate 430 can be removed after the lens is molded without causing an imperfection that might detrimentally affect alignment tolerances of the lens.

It should be recognized that alternate configurations are possible. In another embodiment, the outer diameter in this dimension is formed by both the A-side and B-side receivers. In another embodiment, the outer diameter in this dimension is formed by the A-side receiver only. In yet another embodiment, the outer diameter in this dimension is formed by the B-side optic pin only.

FIG. 7A illustrates a front view of one embodiment of a miniature lens formed using the receiver assemblies depicted in FIGS. 6A-D; and FIG. 7B illustrates a rear view of one embodiment of the miniature lens illustrated in FIG. 7A. FIG. 7E illustrates a front perspective view of one embodiment of the miniature lens illustrated in FIG. 7 A; and FIG. 7F illustrates a rear perspective view of one embodiment of the miniature lens illustrated in FIG. 7A. FIG. 7C illustrates a side view of the miniature lens illustrated in FIG. 7A; and FIG. 7D illustrates a cross-sectional view of the side view of the miniature lens illustrated in FIG. 7C taken along line 7D-7D. The lens 700 includes an A-side optical surface 730, mechanical locating flanges 705, 710, relieved flanges 715, 720, and a B-side optical surface 755. In the illustrated embodiment, the A-side optical surface 730 is formed by the A-side optical pin 200, and the B-side optical surface 755 is formed by the B-side optic pin 300. Like the B-side optical surface 755, the mechanical locating flanges 705, 710 are also formed by the B-side optic pin 300, with the attendant benefits of improving alignment of the B-side optical surface 755 with the mechanical locating flanges 705, 710. The relieved flanges 715, 720, which, in the illustrated embodiment, do not serve an alignment function, are formed by the B-side receiver 400. As indicated above, in other embodiments, the relieved flanges 715, 720 may be formed by the B-side optic pin 300, the A-side receiver 514, and/or the A-side optic pin 200. Also, in some embodiments, the mechanical locating flange 705, 710 may be alternatively formed by the A-side optic pin 200. Other variations are possible.

As illustrated, the mechanical locating flanges 705, 710 and the relieved flanges 715, 720 are tapered along their height. In various embodiments, these flanges are tapered so as to facilitate ejection from the B-side pin. A non-tapered surface can introduce ejection problems because it may produce a high-friction surface for part removal which could, among other things, cause part distortion and/or part sticking. Two ejection techniques are described in more detail below with respect to FIG. 8.

FIG. 8 illustrates one embodiment of a flowchart for manufacturing a miniature lens. The process 100 for manufacturing a lens begins 105 by injecting material used to manufacture the lens into the mold cavity via the gate 110. As, described above, the material used for the lens may vary and includes, for example, plastics or other polymer materials such as, for example, acrylic polycarbonate and polyolefins, although other materials may be used. In some embodiments, the material used for the lens flows into the mold cavity.

Next, pressure may be applied to the lens material in the mold cavity either by increasing the pressure under which lens material is flowed into the mold cavity or by applying a force to the B-side optic pin 115. For example, as depicted, a force on the B-side optic pin 300 to the left (see FIGS. 6A-6D) would put pressure on the lens material in the mold cavity. In this step 115, the lens material is formed into the lens shape according to the contours of the mold cavity. After the lens material forms into the lens shape and hardens, the pressure on the mold cavity is relieved 120. In one embodiment, the lens material hardens by applying an ultraviolet light to an ultraviolet-curable lens material. In another embodiment, the lens material hardens by cooling inside the mold cavity. In a further embodiment, the lens material hardens over time. Other methods may also be used to cure the material. Additionally, it should be noted that in some embodiments, pressure is not required to form the lens within the mold cavity. Similarly, other processes may be used to form the lens from a material.

After the lens has been formed, the A-side and B-side receivers are separated 125, and the lens is ejected from the receiver assembly 125. In practice, the lens 700 can be either optically ejected or non-optically ejected from the mold. Optical ejection begins by separating the B-side 400 and A-side 514 receivers. As a result, the lens generally adheres to the B-sidc optic pin because the outer diameter is entirely formed by the B-side of the mold. To eject the pin from the mold, the B-side optic pin 300 is extended from the B-side receiver 400 or retracted into the B-side receiver 400. In other words, as depicted in FIG. 6A, optical ejection could be accomplished by moving the B-side optic pin 300 to the left or to the right. The relieved flanges 715, 720 contact the receiver 400 when the optic pin 300 is moved because the receiver 400 forms the relieved flanges 715, 720 which are wider in that dimension than the optic pin 300.

Alternatively, in some embodiments, non-optical ejection may be used to remove the lens from the mold. In non-optical ejection, very small ejector pins (for example, 800 microns in diameter) are located in the B-side receiver near the optic pin insertion cavity 420. When the ejector pins are extended, the lens is separated from the receiver 400 and optic pin 300. In other embodiments, lifters or other mechanical features are used to lift a flange or other lens portion in order to remove the lens. After the lens has been ejected, the lens forming process ends 135.

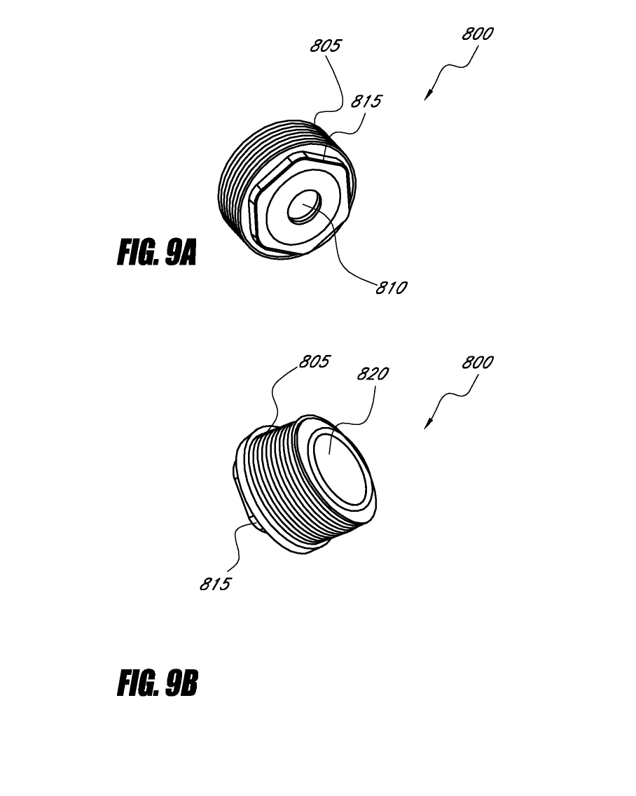

FIG. 9A illustrates a top perspective view of one embodiment of a lens assembly housing; and FIG. 9B illustrates a bottom perspective view of the lens assembly housing illustrated in FIG. 9A. The lens housing 800 includes an aperture 810, a focus element 815, a barrel 805, and back 820. The lens housing 800 houses a lens assembly comprised of one or more lenses. The lens(es) fit within the barrel 805 and the focus element 815 can be rotated to change the distance between the aperture 810 and a detector array (not shown) located behind the back 820 of the lens housing 800. In other embodiments, the distance between the aperture and the detector array can be altered by slidably moving the focus element away or toward the detector array. Other arrangements may also be used.

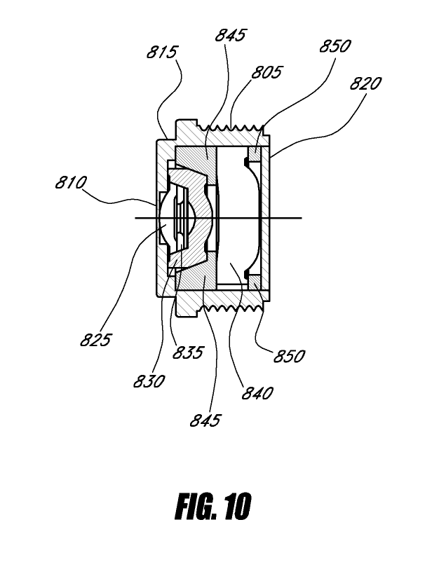

FIG. 10 illustrates a cross-sectional view of one embodiment of a lens assembly. The lens assembly fits within the barrel 805 of the lens housing 800 and includes three lenses 825, 830, and 840. Light passes through aperture 810 to the first lens 825. Then, light passes through a second aperture 835 to the second lens 830. The first 825 and second lenses 830 are spaced according to the outer diameter of the first lens 825 that is in contact with the second lens 830. Light from the second lens 830 then passes through the third lens 840 and then through the back of the lens housing 800 to a detector array. Lens two 830 is separated from lens three 840 via circular spacer 845, and lens three 840 is separated from the back 820 of the lens housing 800 via circular spacer 850.

It is recognized that lens assemblies can have many other configurations. Moreover, lens assemblies can have more or fewer elements including more or fewer lenses. Additionally, in some configurations, all of the lenses may be in direct contact with one another. In other configurations, at least two lenses contact each other.

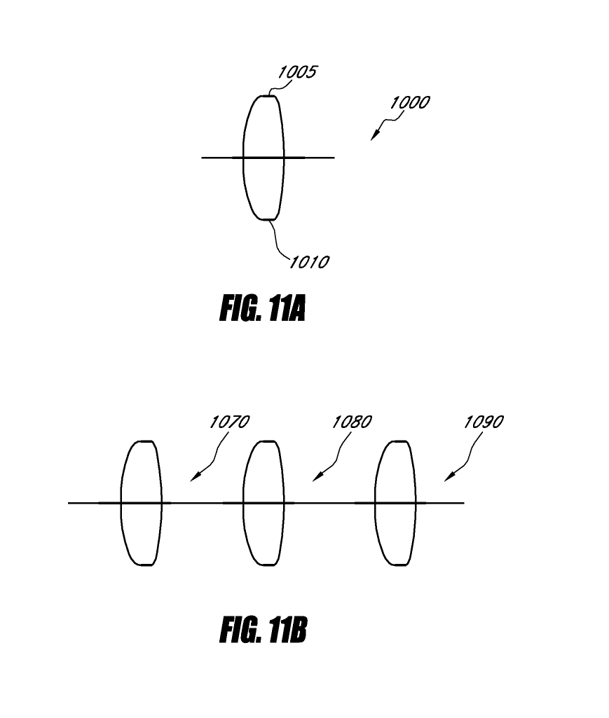

FIG. 11A illustrates a side view of one embodiment of an ideal lens. In an ideal lens, the optical axis of the A-side of the lens, the optical axis of the B-side of the lens, and the mechanical axis of the lens are aligned. The optical axis of a lens is defined by an optical surface of the lens and is a term of art understood by those that work in the fields of optic design and optic manufacturing. The mechanical axis of the lens is defined by the outer diameter of the lens and is also a term of art understood by those that work in the fields of optic design and optic manufacturing. In FIG. 11A, the mechanical axis of the lens 1000 is defined by the outer diameter at points 1005 and 1010.

FIG. 11B illustrates a side view of one embodiment of a 3-lens lens assembly comprised of lenses similar to the lens illustrated in FIG. 11A. In FIG. 11A, all of the lenses 1070, 1080 and 1090 are ideal lenses. That is, each has a mechanical axis and an optical axis that are aligned. Moreover, the lens assembly comprising the three lenses 1070, 1080, and 1090 is also ideal. That is, the aligned axes of each of the three lenses are also aligned. Therefore, there is no error in the depicted lens assembly on either a per-lens or a lens-to-lens basis. No known high volume lens manufacturing technique is capable of producing ideal lenses and ideal lens assemblies.

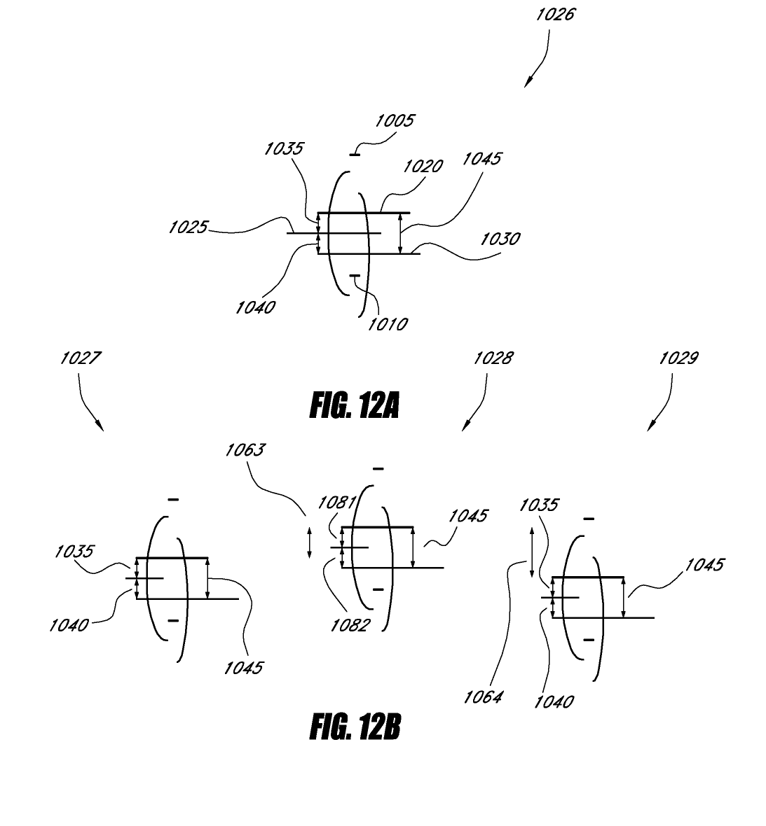

FIG. 12A schematically illustrates a side view of one embodiment of a lens having alignment errors. Lens 1026 has the following sources of error: misalignment 1035 between the mechanical axis 1020 and the A-side optical axis 1025, misalignment 1045 between the mechanical axis 1020 and the B-side optical axis 1030, and misalignment 1040 between the A-side 1025 and B-side optical axes 1030. These errors adversely impact the resolution/quality of an image produced by the lens. Moreover, when lens-to-lens alignment errors are considered, the errors are further exacerbated. For example, FIG. 12B illustrates a side view of one embodiment of a 3-lens lens assembly comprised of lenses similar to the lens illustrated in FIG. 12A. In addition to the per-lens alignment errors, there are two lens-to-lens alignment errors that degrade performance of the lens assembly: misalignment 1063 between lens one 1027 and lens two 1028, and the misalignment 1064 between lens two 1028 and lens three 1029.

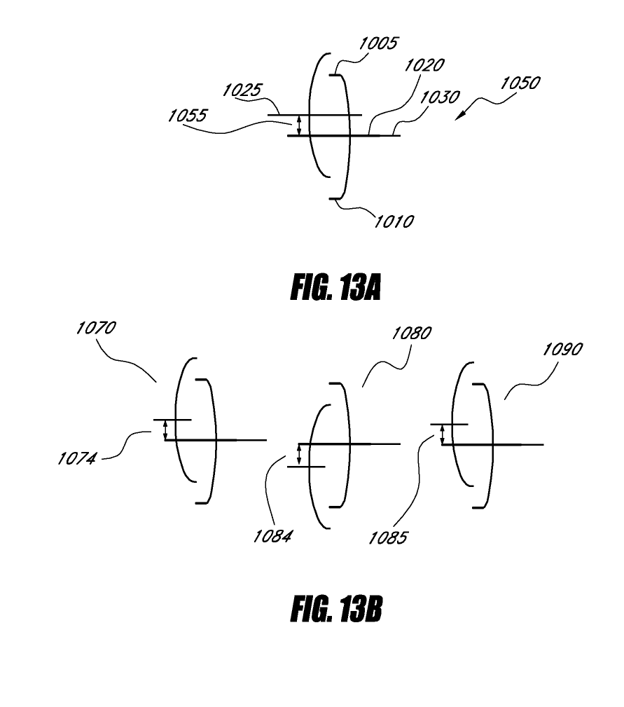

FIG. 13A illustrates a side view of one embodiment of a lens 1050 having reduced alignment errors as a result of the manufacturing techniques described herein: namely, manufacturing techniques that create mechanical alignment surfaces (e.g., a tapered surface) of the lens using the same tooling, the same optic pin, and in the same operation as one of the optical surfaces. Accordingly, only a single tolerance need be considered for this lens 1050: the misalignment 1055 between the A-side optical axis 1025 and the B-side optical axis 1030. The alignment errors between the B-side optical axis 1030 and the mechanical axis 1020 are substantially reduced because the outer diameter alignment surface of the lens and the B-side optical surface are created in a single step by the B-side optical pin 300 (which was created in a single diamond turning process). This also results in the alignment between the A-side optical axis 1025 and the mechanical axis 1020 being conflated with the alignment between the A-side optical axis 1025 and the B-side optical axis 1030. The end result is a lens assembly having improved alignment tolerances, as illustrated in FIG. 13B.

FIG. 13B illustrates a side view of one embodiment of a 3-lens lens assembly comprised of lenses similar to the lens illustrated in FIG. 13A. Because the lenses can be precisely mechanically centered, there is little lens-to-lens error that must be considered because each lens's B-side optical axis is substantially aligned with its respective mechanical axis. Consequently, in a lens assembly comprising lenses 1070, 1080, and 1090, each being similar to lens 1050, the tolerance stack has only three errors: error 1074, error 1084, and error 1085. Therefore, comparing the lens assembly of FIG. 12B with FIG. 13B reveals the inherently lower tolerance stack experienced when a lens's outer diameter alignment surface(s) and one of its optical surfaces are created by a single optic pin, which is created by a single machining operation, rather than the combination of an optic pin and a receiver as in conventional lens molding processes. It is foreseeable that alignment tolerances between the optical axes of two or more lenses in a lens assembly can be reduced below 5 microns using the manufacturing methods and apparatuses disclosed herein. In some embodiments, it is foreseeable that alignment tolerances between the optical axes of two or more lenses in a lens assembly can be reduced below 3 microns using the manufacturing methods and apparatuses disclosed herein. In certain embodiments, it is foreseeable that alignment tolerances between the optical axes of two or more lenses in a lens assembly can be reduced to 1 micron or less using the manufacturing methods and apparatuses disclosed herein.

While certain embodiments of the invention have been described, these embodiments have been presented by way of example only, and are not intended to limit the scope of the present invention. Accordingly, the breadth and scope of the present invention should be defined in accordance with the following claims and their equivalents.

What is claimed is:

1. A method for manufacturing a lens for use in a miniature camera assembly, the lens shaped to mount the lens with improved tolerance, comprising:
providing first and second receivers respectively housing first and second optic pins, each of said optic pins having distal ends respectively contoured to form first and second optical surfaces of said lens,
disposing said first optic pin and receiver with respect to said second optic pin and receiver to form a cavity;
forming a lens by flowing material into said cavity, said lens having first and second optical surfaces respectively formed by said optic pins, said lens having a first outer diameter across a first direction and a second outer diameter across a second direction, said first outer diameter being larger than said second outer diameter, said first outer diameter for mounting of said lens independent of said second outer diameter; and
removing the lens from said first and second receivers, after the plastic material has hardened,
wherein said first optical surface is formed by said first optic pin, and said second optical surface and said first outer diameter are formed by said second optic pin thereby reducing error in alignment of said second optical surface with said first outer diameter.

2. A method for manufacturing a lens having first and second optical surfaces for use in a miniature camera assembly, said method comprising:
providing a first optic pin having a shape conforming to said first optical surface;
providing a second optic pin having a shape conforming to said second optical surface and to a locating flange for said lens;
juxtaposing said first and second optic pins to form a cavity, one of said first and second optic pins being provided in a receiver;
flowing plastic material into said cavity to form said lens having said first and second optical surfaces, said locating flange formed substantially only by said second optic pin and substantially independent of said receiver.

3. A method for manufacturing a lens for use in a miniature camera assembly, the lens shaped to mount the lens with improved tolerance, comprising:
providing first and second receivers respectively housing first and second pins, each of said pins and said receivers having distal ends;
disposing the distal end of said first pin and said first receiver with respect to the said second pin and said second receiver to form a cavity;
forming a lens from material in said cavity, said lens having first and second optical surfaces and a flange thereabout, said lens having a first outer diameter across a first direction and a second outer diameter across a second direction that is orthogonal to the first direction, said first outer diameter being larger than said second outer diameter, said first outer diameter for mounting of said lens; and
removing the lens,
wherein said second optical surface and said first outer diameter are formed by said second pin thereby reducing error in alignment of said second optical surface with said first outer diameter.

4. The method of claim 3, wherein the distal end of at least one of said first and second pins is contoured to provide curvature to at least one of said first and second optical surfaces.

5. The method of claim 4, wherein the distal end of one of said receivers is contoured to form said second outer diameter.

6. The method of claim 3, wherein said material is flowable.

7. The method of claim 3, wherein said material comprises a plastic or a polymer.

8. The method of claim 3, further comprising disposing said material between said first or second pin and applying pressure to said material.

9. The method of claim 3, wherein said material is injected through a gate in at least one of said receivers.

10. The method of claim 3, wherein removing the lens comprises separating the first pin and the first receiver from the second pin and the second receiver such that said lens remains adhered to one of said first pin or first receiver, or to said second pin or second receiver, and ejecting the lens therefrom.

11. The method of claim 3, wherein removing comprises optical ejection.

12. The method of claim 3, wherein removing comprises non-optical ejection.

13. The method of claim 3, wherein said first optical surface is formed by said first pin.

14. The method of claim 3, wherein said second outer diameter is formed by said second receiver.

15. The method of claim 3, wherein said first outer diameter is independent of said first pin.

16. A method for manufacturing a lens, comprising:
disposing a first member with respect to a second member to form a cavity therebetween, said second member including a monolithic contoured surface;
forming a lens from material in said cavity, said lens having first and second optical surfaces and a locating flange disposed about at least a portion of said first and second optical surfaces, said locating flange having an outer diameter; and
removing the lens,
wherein said second optical surface and said outer diameter of said locating flange are formed by said monolithic contoured surface thereby reducing error in alignment of said second optical surface with said outer diameter.

17. The method of claim 16, wherein said second optical surface and said outer diameter of said locating flange are formed exclusively by said monolithic contoured surface.

18. The method of claim 16, wherein said material is flowable.

19. The method of claim 16, wherein said material comprises a plastic or a polymer.

20. The method of claim 16, further comprising disposing said material between said first or second member and applying a force to said material.

21. The method of claim 16, wherein removing comprises optical ejection.

22. The method of claim 16, wherein removing comprises non-optical ejection.

23. The method of claim 16, wherein said outer diameter is independent of said first member.

24. An optic pin for manufacturing a miniature plastic lens, comprising:
a body;
an optical forming surface on a distal end of said body; and
a locating flange forming surface on the distal end of said body,
wherein said optical forming surface and said locating flange forming surface comprise a monolithic contoured surface.

25. The optic pin of claim 24, wherein said optical forming surface and said locating flange forming surface are created in a single machining operation.

26. The optic pin of claim 24, wherein at least a portion of said distal end is electroless-nickel plated stainless steel.

27. The optic pin of claim 24, wherein said distal end further comprises relieved flange surfaces for optical ejection.

28. The optic pin of claim 24, wherein said distal end further comprises ejection surfaces for non-optical ejection.
